(19) United States
(12) Patent Application Publication
(10) Pub. No.: US 2021/0382460 A1
(43) Pub. Date: Dec. 9, 2021

(54) Production Information Generation System, Production Information Generation Device, and Production Information Generation Method

(71) Applicant: Hitachi, Ltd., Chiyoda-ku, Tokyo (JP)

(72) Inventors: Yumiko UENO, Tokyo (JP); Youichi NONAKA, Tokyo (JP); Daisuke TSUTSUMI, Tokyo (JP)

(21) Appl. No.: 17/285,327

(22) PCT Filed: Aug. 23, 2019
(86) PCT No.: PCT/JP2019/032989

§ 371 Date: Apr. 14, 2021

(30) Foreign Application Priority Data
Oct. 17, 2018 (JP) 2018-195772

(51) Int. Cl. G05B 19/418

(52) U.S. Cl. CPC G05B 19/4185; G05B 19/4183; G05B 19/41885; G05B 19/41865

(57) ABSTRACT

A production information generation system includes a production information generation device and a work instruction information output device. The production information generation device includes a storage unit for storing actual information containing an actual value of worktime in a process and a throughput of a product, and work promotion master information, a worktime function calculation unit for calculating a worktime function for each process and each worker, the worktime function indicating a correlation of actual information, a worktime for each capability calculation unit for calculating worktime for each capability for obtaining a predetermined throughput by using the worktime function; a work instruction information generation unit for generating, for each worker, work instruction information containing the worktime for each capability and the work promotion information; and a transmitter for transmitting the work instruction information to the work instruction information output device, and the work instruction information output device including an output unit for displaying the worktime for each capability.

### TECHNICAL FIELD

The present invention relates to a production information generation system, a production information generation device, and a production information generation method. The present invention claims priority to Japanese Patent Application No. 2018-195772, filed on Oct. 17, 2018, the contents of which are incorporated by reference herein in its entirety in designated states where the incorporation of documents by reference is approved.

### BACKGROUND ART

As the background art in this technical field, JP 2009-301292 A (Patent Literature 1) is disclosed. This literature describes that a variation amount is calculated from data on a production system, a normal production number, and an overtime-work production number in the past and that a possible production system and overtime work are determined with respect to a difference between an actual stock amount and a target amount.

### CITATION LIST

### Patent Literature

PTL 1: JP 2009-301292 A

### SUMMARY OF INVENTION

In the technique in Patent Literature 1 described above, a capability difference among individual workers is not reflected. When workers at different levels of capability are present in an actual situation, a work load is likely to concentrate on some of the workers. This may cause degradation of a defective rate or unexpected reduction of a throughput.

An object of the present invention is to generate, depending on a target throughput, various types of production information in which a capability difference among workers, who are in a production line separated into a plurality of steps, is reflected.

### Solution to Problem

The present application includes a plurality of solutions to at least a part of the problems described above. One example of the solutions is as follows. In order to solve the above-mentioned problem, a production information generation system according to one aspect of the present invention includes: a production information generation device; and a work instruction information output device connected to the production information generation device via a network in a communicable manner, the production information generation device including: a storage unit configured to store actual information containing an actual value of worktime in a predetermined process and a throughput of a product, and work promotion master information containing predetermined work promotion information for each process, a worktime function calculation unit configured to calculate a worktime function for each process and each worker, the worktime function indicating a correlation between the actual value of worktime in the process and the throughput of the product; a worktime for each capability calculation unit configured to calculate, for each process and each worker, worktime for each capability for obtaining a predetermined throughput by using the worktime function; a work instruction information generation unit configured to generate, for each worker, work instruction information containing the worktime for each capability and the work promotion information on the process; and a communication unit configured to transmit the work instruction information to the work instruction information output device, and the work instruction information output device including an output unit configured to receive the work instruction information and display at least the worktime for each capability.

### Advantageous Effects of Invention

According to the present invention, it is possible to generate various types of production information, depending on a target throughput, in which a capability difference among workers, who are in a production line separated into a plurality of steps, is reflected. Problems, configurations, and effects other than those described above are defined clearly in the following description of the embodiments.

### BRIEF DESCRIPTION OF DRAWINGS

FIG. 1 is a diagram illustrating a configuration example of a production information generation system according to a first embodiment of the present invention.

FIG. 2 is a diagram illustrating a configuration example of a production information generation device.

FIG. 3 is a diagram illustrating a data structure example of a target throughput information storage unit.

FIG. 4 is a diagram illustrating a structure example of a standard worktime for each process information storage unit.

FIG. 5 is a diagram illustrating a data structure example of a throughput reduction rate information storage unit.

FIG. 6 is a diagram illustrating a data structure example of a worktime for each capability allowable value information storage unit.

FIG. 7 is a diagram illustrating a data structure example of an actual throughput information storage unit.

FIG. 8 is a diagram illustrating a data structure example of a process-basis actual worktime information storage unit.

FIG. 9 is a diagram illustrating a data structure example of a process planning information storage unit.

FIG. 10 is a diagram illustrating a data structure of a production planning information storage unit.

FIG. 11 is a diagram illustrating a data structure example of a work promotion master information storage unit.

FIG. 12 is a diagram illustrating a data structure example of a workability improvement master information storage unit.

FIG. 13 is a diagram illustrating a data structure example of a process-basis work promotion information storage unit.

FIG. 14 is a diagram illustrating a data structure example of a process-basis workability improvement information storage unit.

FIG. 15 is a diagram illustrating a hardware configuration example of the production information generation device.

FIG. 16 is a diagram illustrating an example of throughput management.

FIG. 17 is a diagram illustrating an example of target/actual worktime management.

FIG. 18 is a diagram illustrating a flow of production information generation processing.

FIG. 19 is a diagram illustrating an example of a relationship between a worktime function and worktime for each capability.

FIG. 20 is a diagram illustrating an output screen example for production planning.

FIG. 21 is a diagram illustrating an output screen example for process planning.

FIG. 22 is a diagram illustrating an output screen example for a work instruction.

FIG. 23 is a diagram illustrating an output screen example for a training course.

FIG. 24 is a diagram illustrating a configuration example of a production information generation device according to a second embodiment.

FIG. 25 is a diagram illustrating a data structure example of equipment control information and process-basis equipment control information.

FIG. 26 is a diagram illustrating a data structure example of equipment maintenance information and process-basis equipment maintenance information.

FIG. 27 is a diagram illustrating an example of a flow of production information generation processing (subjecting equipment).

### DESCRIPTION OF EMBODIMENTS

With reference to the drawings, embodiments of the present invention are described below. Note that, in all the drawings for illustrating the embodiments, the same members are basically denoted with the same reference symbols, and repeated description therefor is omitted. In the following embodiments, it is needless to say that the constituent elements (including element steps, and the like) are not necessarily essential unless otherwise particularly specified, obviously considered as essential in principle, or the like. It is needless to say that the expressions “being formed of A”, “being constituted of A”, “having A”, and “including A” are not intended to eliminate other elements unless otherwise explicitly specifying to limit the particular element or the like. Similarly, in the following embodiments, when shapes of the constituent elements and the like, a positional relationship, and the like are referred to, shapes and the like that are substantially close to or similar to the shapes and the like are included unless otherwise particular specified, clearly considered to be exceptional in principle, or the like.

In a manufacturing site, it is assumed that technical knowledge, manual dexterity, and a degree of training or experience vary among workers. For example, even in a case of a worker with years of experience, aging leads change in manual dexterity and accuracy. An unexperienced worker with inherent manual dexterity may be a quick learner, improving work efficiency rapidly. It is considered that, regarding a language or a custom, a native speaker and a non-native speaker understand a work instruction at different levels. In addition to workers, performance varies among machines or equipment such as an automation work device that performs part of work. This depends on, for example, a defect rate due to performance of equipment or aged deterioration of equipment. Thus, in a manufacturing site, a work manager has a role of adjusting such variations and securing a production throughput.

Leveling the variations leads to a long-term stable operation, but at the same time, manufacturing needs to be performed while allowing the variations. In the present invention, in view of such circumstances, depending on a target throughput, various types of production information are generated, the information in which a capability difference among workers, who are in a production line separated into a plurality of steps, is reflected.

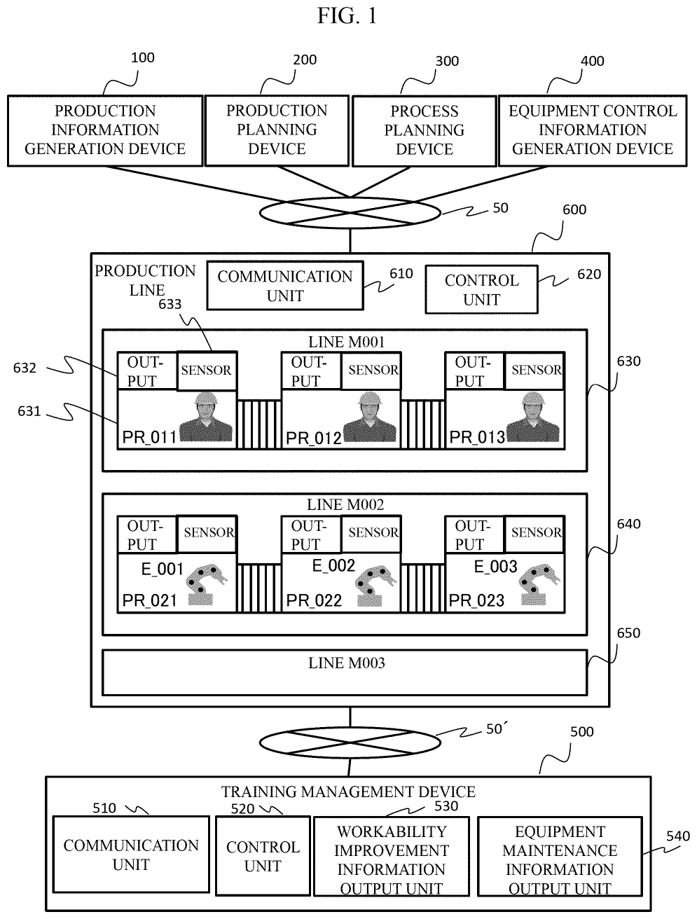

FIG. 1 is a diagram illustrating a configuration example of a production information generation system according to a first embodiment of the present invention. The production information generation system includes a production information generation device 100, a production planning device 200, a process planning device 300, an equipment control information generation device 400, a network 50 that connects those devices to one another and enables communication therebetween, a production line 600 that is connected to the network 50 and is controlled, and a training management device 500 that is connected to the production line 600 via another network 50′.

The network 50 and such another network 50′ connects the production information generation device 100, the production planning device 200, the process planning device 300, the equipment control information generation device 400, the production line 600, and the training management device 500 to one another, and enables communication therebetween. It is assumed that such another network 50′ is different from the network 50 for the sake of convenience, but may be the same network. Particularly, it is only required that data can be exchanged between the training management device 500 and the production information generation device 100. For example, the network 50 and such another network 50′ are any of local area network (LAN), wide area network (WAN), virtual private network (VPN), and a communication network using a general public line such as the Internet as a part or the whole.

In a factory that produces products, a plurality of individual production lines (a line M001 (630), a line M002 (640), a line M003 (650), and the like in FIG. 1) are provided, and form the production line 600 as a whole. Each of the individual production lines includes a plurality of processes 631 (PR_011, PR_012, PR_013, and the like). In each of the processes 631, a worker, equipment such as an automated machine, or both of the two performs work in the process 631. After the work in each of the processes 631 is completed, a semimanufactured product is transferred to the next process, and thus a final product is assembled.

Each of the processes 631 is provided with an output unit 632 that displays a work content, standard worktime for each process, process-basis worktime for each capability, work promotion information, equipment control information, and the like. Each of the processes 631 is provided with a sensor 633 and the like that acquire process-basis actual time from a completion time point when work for each product is completed, or the like. The sensor 633 includes various types of measurement instruments that are used to grasp a work state, such as a camera for obtaining a captured image of a worker, a component, and the like, a thermometer or a hygrometer for measuring temperature, humidity, or the like, a pressure sensor for measuring a pressure. Data obtained by the sensor is collected via the network 50 or the like, and is stored in a storage unit in the production information generation device 100.

The production information generation system includes the production planning device 200 that specifies the daily production number of products produced in the production line 600. The production information generation system includes the process planning device 300 that specifies a work content and equipment allocation for each of the processes 631 in the individual production line, and the equipment control information generation device 400 that specifies equipment control information.

Furthermore, the production information generation system is provided with the training management device 500 for the purpose of improving capability of a worker. The training management device 500 includes an output unit that displays workability improvement information, and is provided with a sensor and the like that acquire various types of information during work when performing the work in accordance with workability improvement information. The various types of information during the work are also managed by the production information generation device 100 via such another network 50 or the like.

The production information generation device 100 collects a target throughput from the production planning device 200, process-basis standard time from the process planning device 300, and an actual throughput and process-basis actual worktime in each process from the sensor 633 of the production line 600 via the network or the like. With this, calculation of a worktime function and calculation of worktime for each capability can be performed. The process-basis worktime for each capability calculated by the production information generation device 100, process-basis work promotion information, process-basis workability improvement information, process-basis equipment control information, and process-basis equipment maintenance information can be displayed on the output unit 632 in each process and the training management device 500 via the network 50 or such another network 50′.

The production information generation device 100, the production planning device 200, the process planning device 300, the equipment control information generation device 400, and the training management device 500 are information processing devices such as a personal computer (PC), a server computer, and the like. The production information generation device 100, the production planning device 200, the process planning device 300, the equipment control information generation device 400, and the training management device 500 are configured with devices independent from one another for the sake of convenience. However, the devices are not limited thereto, and a single device may have the functions of the devices.

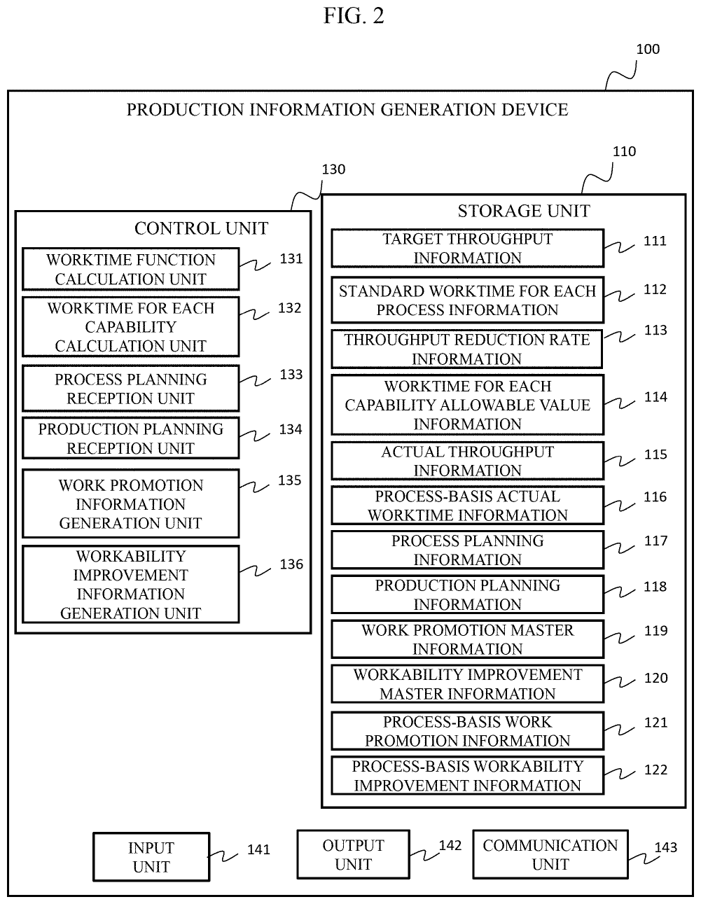

FIG. 2 is a diagram illustrating a configuration example of the production information generation device. The production information generation device 100 includes a storage unit 110, a control unit 130, an input unit 141, an output unit 142, and a communication unit 143.

The storage unit 110 includes target throughput information 111, standard worktime for each process information 112, throughput reduction rate information 113, worktime for each capability allowable value information 114, actual throughput information 115, process-basis actual worktime information 116, process planning information 117, production planning information 118, work promotion master information 119, workability improvement master information 120, process-basis work promotion information 121, and process-basis workability improvement information 122.

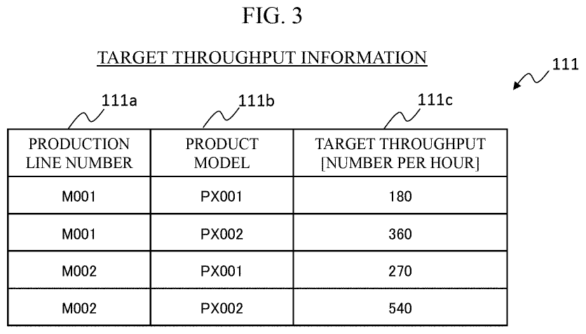

FIG. 3 is a diagram illustrating a data structure example of a target throughput information storage unit. The target throughput information 111 contains information pieces of a production line number 111a, a product model 111b, and a target throughput 111c. The production line number 111a is information for specifying an individual production line constituting the production line 600. The product model 111b is information for specifying a product or a component to be produced. The target throughput 111c is the number of products that are produced per unit time. The information on the target throughput 111c is a type of data determined in view of the number of products for a product model requested by a client or the number of products that can be produced in a production line. Thus, in the present embodiment, the information is set for each combination of the production line number 111a and the product model 111b.

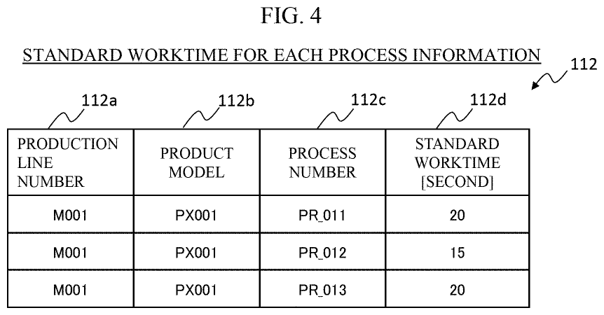

FIG. 4 is a diagram illustrating a structure example of a standard worktime for each process information storage unit. The standard worktime for each process information 112 contains information pieces of a production line number 112a, a product model 112b, a process number 112c, and standard worktime 112d. The production line number 112a is information for specifying an individual production line constituting the production line 600. The product model 112b is information for specifying a product or a component to be produced. The process number 112c is information for specifying a production process constituting the production line. The standard worktime 112d indicates standard time required for work in a process. When a production process for a product is determined, work information containing an assembling order and an assembling method of components is determined based on a constituent members and a structure of a product model to be produced. Further, for the purpose of achieving the target throughput, the work information is divided into a plurality of processes, the number of workers and performance and the number of automated equipment pieces in the production line are allocated, and standard time required for work in each process is set as standard worktime for each process.

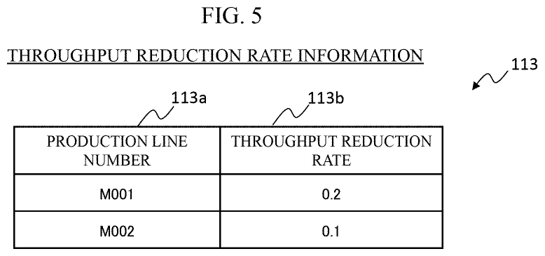

FIG. 5 is a diagram illustrating a data structure example of a throughput reduction rate information storage unit. The throughput reduction rate information 113 contains information pieces of a production line number 113a and a throughput reduction rate 113b. The production line number 113a is information for specifying an individual production line constituting the production line 600. The throughput reduction rate 113b is information for specifying a reduction ratio with respect to the target throughput or the number of reduced throughputs.

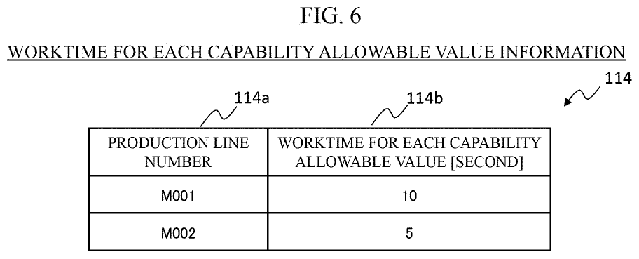

FIG. 6 is a diagram illustrating a data structure example of a worktime for each capability allowable value information storage unit. The worktime for each capability allowable value information 114 contains information pieces of a production line number 114a, and a worktime for each capability allowable value 114b. The production line number 114a is information for specifying an individual production line constituting the production line 600. The worktime for each capability allowable value 114b is a threshold value that is used for determining a magnitude of a difference between process-basis actual time and process-basis worktime for each capability calculated in one of the processes in the present embodiment. Note that the worktime for each capability allowable value information 114 is associated with the production line number 114a on the assumption that the information is set for each production line number. However, setting may be performed in more detail, for example, for each product model or each process number.

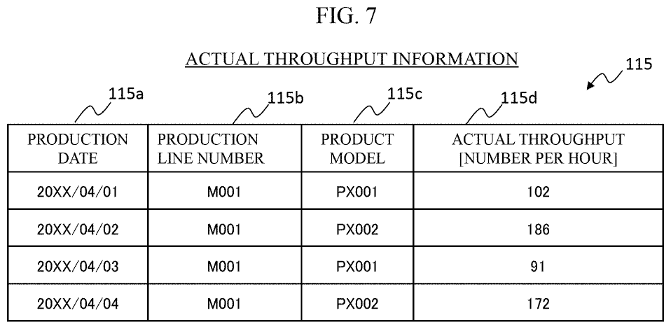

FIG. 7 is a diagram illustrating a data structure example of an actual throughput information storage unit. The actual throughput information 115 contains information pieces of a production date 115a, a production line number 115b, a product model 115c, and an actual throughput 115d. The production date 115a is not limited to a “date” unit, and may indicate various periods in a “month” unit, a “week” unit, an “hour” unit, or the like. The production line number 115b is information for specifying an individual production line constituting the production line 600. The product model 115c is information for specifying a product or a component to be produced. The actual throughput 115d is an actual value of the number of products produced per unit time.

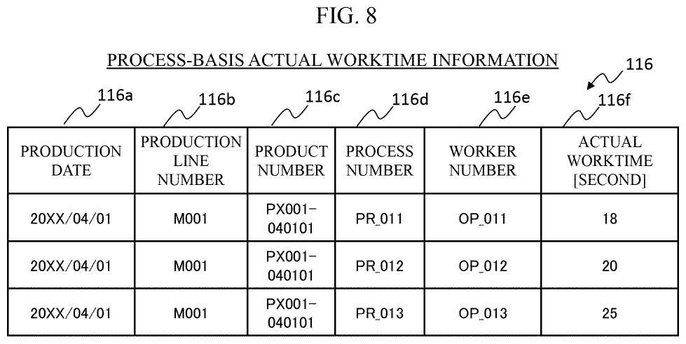

FIG. 8 is a diagram illustrating a data structure example of a process-basis actual worktime information storage unit. The process-basis actual worktime information 116 contains information pieces of a production date 116a, a production line number 116b, a product number 116c, a process number 116d, a worker number 116e, and actual worktime 116f. The production date 116a is not limited to a “date” unit, and may indicate various periods in a “month” unit, a “week” unit, an “hour” unit, or the like. The production line number 116b is information for specifying an individual production line constituting the production line 600. The product number 116c is information for specifying an individual product or component that is produced. The process number 116d is information for specifying a production process constituting the production line. The worker number 116e is information for specifying an allocated person or allocated equipment for production. The actual worktime 116f indicates an actual value of time required for work in a process.

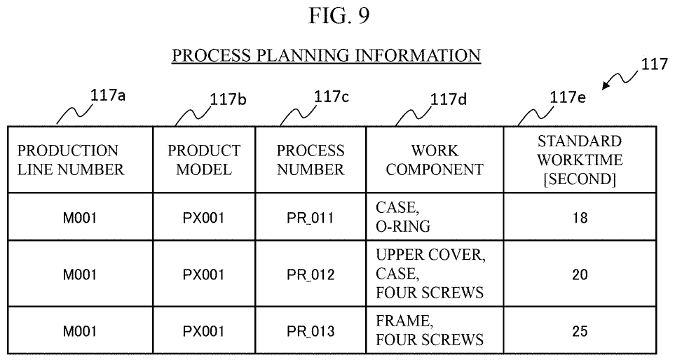

FIG. 9 is a diagram illustrating a data structure example of a process planning information storage unit. The process planning information 117 contains information pieces of a production line number 117a, a product model 117b, a process number 117c, a work component 117d, and standard worktime 117e. Note that used equipment, a work content, and the like may be additionally contained. The production line number 117a is information for specifying an individual production line constituting the production line 600. The product model 117b is information for specifying a product or a component to be produced. The process number 117c is information for specifying a production process constituting the production line. The work component 117d is information for specifying a component that is used in a process. The standard worktime 117e indicates time predetermined as standard time required for work in a process.

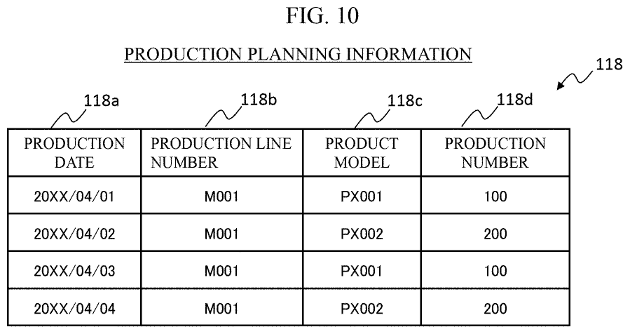

FIG. 10 is a diagram illustrating a data structure of a production planning information storage unit. The production planning information 118 contains information pieces of a production date 118a, a production line number 118b, a product model 118c, and the number of productions 118d. In addition, time, a delivery destination, a cell number or a process number in a line, and the like may be contained. The production date 118a is not limited to a “date” unit, and may indicate various periods in a “month” unit, a “week” unit, an “hour” unit, or the like. The production line number 118b is information for specifying an individual production line constituting the production line 600. The product model 118c is information for specifying a product or a component to be produced. The production number 118d indicates the number of products to be produced on a production date.

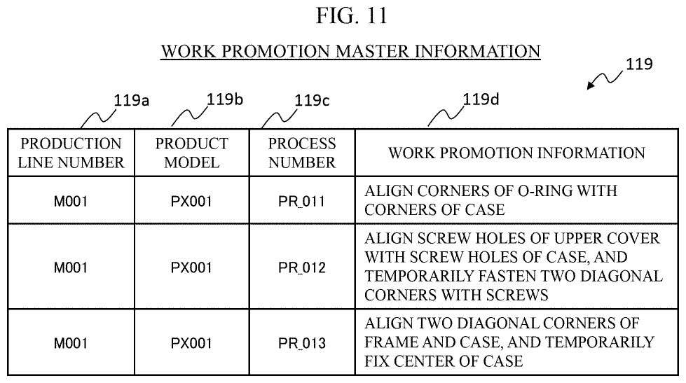

FIG. 11 is a diagram illustrating a data structure example of a work promotion master information storage unit. The work promotion master information 119 contains information pieces of a production line number 119a, a product model 119b, a process number 119c, and work promotion information 119d. Further, a workability level may be additionally contained in the work promotion master information 119, and work promotion information may be associated with each workability level. The production line number 119a is information for specifying an individual production line constituting the production line 600. The product model 119b is information for specifying a product or a component to be produced. The process number 119c is information for specifying a production process constituting the production line. The work promotion information 119d is information indicating a tip on work such as character information as in FIG. 11. However, the information may be a three-dimensional animation of a component, a captured image of an animation, or a photograph of work.

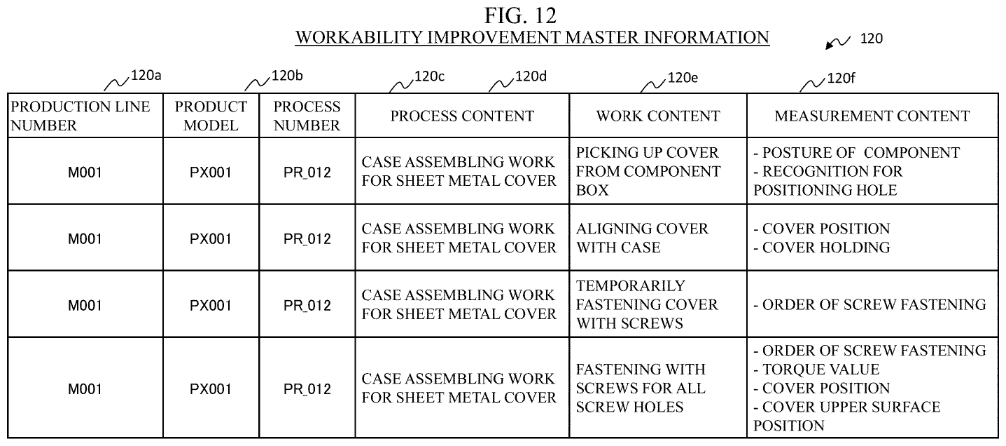

FIG. 12 is a diagram illustrating a data structure example of a workability improvement master information storage unit. The workability improvement master information 120 contains information pieces of a production line number 120a, a product model 120b, a process number 120c, a process content 120d, a work content 120e, and a measurement content 120f. The production line number 120a is information for specifying an individual production line constituting the production line 600. The product model 120b is information for specifying a product or a component to be produced. The process number 120c is information for specifying a production process constituting the production line.

The process content 120d is obtained by putting a process content in a form of language. Examples include “case assembling work for a sheet metal cover” and the like. The work content 120e is obtained by putting an action of a worker in a form of language. For example, in a process number “PR_012”, each of “picking up a cover from a component box”, “aligning the cover with a case”, “temporarily fastening the cover with screws”, and “fastening with the screws for all screw holes” is a work content. The measurement content 120f is information for specifying an item being an action of a worker, which is measured with the sensor 633 or the like.

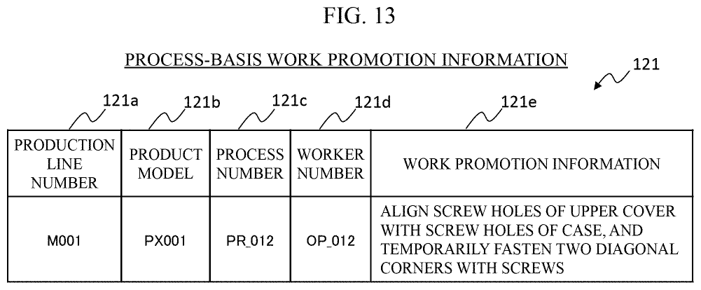

FIG. 13 is a diagram illustrating a data structure example of a process-basis work promotion information storage unit. The process-basis work promotion information 121 contains information pieces of a production line number 121a, a product model 121b, a process number 121c, a worker number 121d, and work promotion information 121e. Further, a workability level may be additionally contained in the process-basis work promotion information 121, and work promotion information may be associated with each workability level. The process-basis work promotion information 121 basically has a data structure similar to that of the work promotion master information 119, and is different in that the worker number 121d for specifying a worker or work equipment is added.

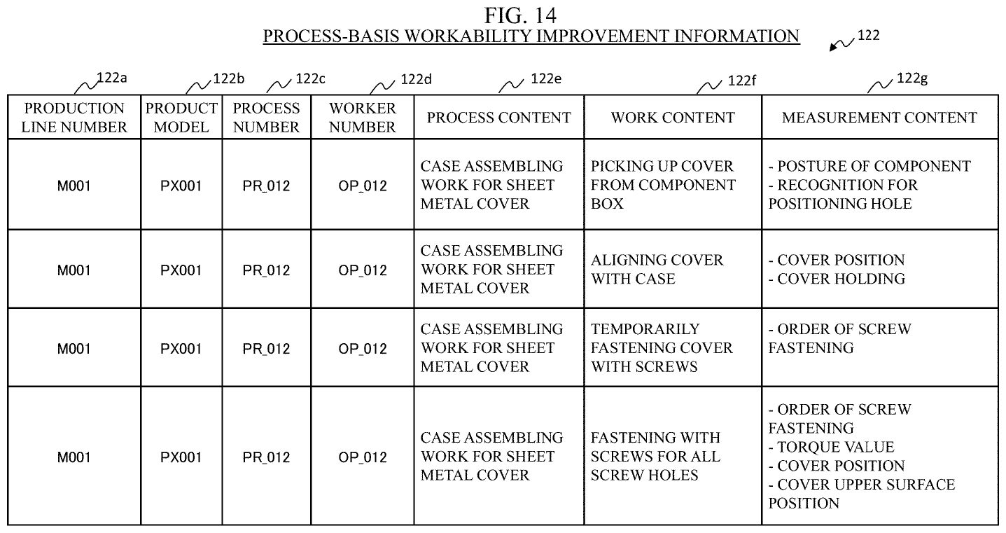

FIG. 14 is a diagram illustrating a data structure example of a process-basis workability improvement information storage unit. The process-basis workability improvement information 122 contains information pieces of a production line number 122a, a product model 122b, a process number 122c, a worker number 122d, a process content 122e, a work content 122f, and a measurement content 122g. The production line number 122a is information for specifying an individual production line constituting the production line 600. The product model 122b is information for specifying a product or a component to be produced. The process number 122c is information for specifying a production process constituting the production line.

The worker number 122d is information for specifying a worker or work equipment. The process content 122e is obtained by putting a process content in a form of language. Examples include “case assembling work for a sheet metal cover” and the like. The work content 122f is obtained by putting an action of a worker in a form of language. For example, in a process number “PR_012”, each of “picking up a cover from a component box”, “aligning the cover with a case”, “temporarily fastening the cover with screws”, and “fastening with the screws for all screw holes” is a work content. The measurement content 122g is information for specifying an item being an action of a worker, which is measured with the sensor 633 or the like. The process-basis workability improvement information 122 basically has a data structure similar to that of the workability improvement master information 120, and is different in that the worker number 122d for specifying a worker or work equipment is added.

Description refers back to FIG. 2. The control unit 130 of the production information generation device 100 includes a worktime function calculation unit 131, a worktime for each capability calculation unit 132, a process planning reception unit 133, a production planning reception unit 134, a work promotion information generation unit 135, and a workability improvement information generation unit 136.

The worktime function calculation unit 131 calculates a worktime function by using the target throughput information 111, the standard worktime for each process information 112, the actual throughput information 115, and the process-basis actual worktime information 116. A worktime function calculation method is described later.

The worktime for each capability calculation unit 132 calculates worktime for each capability by using the calculated worktime function and the throughput reduction rate read out from the throughput reduction rate information 113.

When a difference between the calculated worktime for each capability and the process-basis actual worktime 116f of the process-basis actual worktime information 116 is greater than the worktime for each capability allowable value 114b, the process planning reception unit 133 transmits the process planning information and the process-basis actual worktime to the process planning device 300 being an external system, and receives new process planning information and worktime for each capability that are transmitted back from the process planning device 300.

The production planning reception unit 134 transmits the worktime for each capability and the production planning information to the production planning device 200 being an external system, and receives new production planning information that is transmitted back from the production planning device 200.

The work promotion information generation unit 135 generates information for presenting work promotion information displayed for a worker with work efficiency lower than the standard. Specifically, when the calculated worktime for each capability is greater than the standard worktime for each process 112d, the work promotion information generation unit 135 generates process-basis work promotion information in the corresponding process by using the work promotion master information.

The workability improvement information generation unit 136 generates information for improving workability for a worker who fails to achieve the worktime for each capability. Specifically, when a difference between the worktime for each capability and the process-basis actual worktime 116f is greater than the worktime for each capability allowable value 114b, the workability improvement information generation unit 136 generates process-basis workability improvement information from the workability improvement master information.

The input unit 141 of the production information generation device 100 receives an input. The output unit 142 of the production information generation device 100 outputs information. The communication unit 143 of the production information generation device 100 performs communication with the production planning device 200, the process planning device 300, the equipment control information generation device 400, the production line 600, and the training management device 500, which are devices other than the production information generation device 100, via the network 50 or the network 50′. Note that the production information generation device 100 is a so-called personal computer or work station that is used by a production manager.

Description refers back to FIG. 1. The training management device 500 includes a communication unit 510, a control unit 520, a workability improvement information output unit 530, and an equipment maintenance information output unit 540. The communication unit 510 performs communication with the production information generation device 100 being another device via the network 50 or the network 50′.

The control unit 520 generates a training content by using the received workability improvement information or equipment maintenance information. The workability improvement information output unit 530 outputs the workability improvement information received from the production information generation device 100. The equipment maintenance information output unit 540 outputs the equipment maintenance information received from the production information generation device 100.

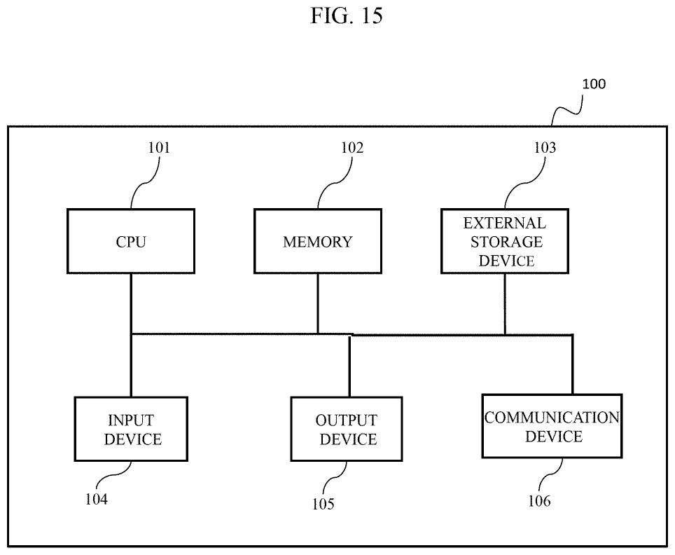

FIG. 15 is a diagram illustrating a hardware configuration example of the production information generation device. The production information generation device can be implemented by a computer including a central processing unit (CPU) 101, a memory 102, an external storage device 103 such as a hard disk drive (HDD), an input device 104 such as a keyboard, a mouse, and a sensor, an output device 105 such as a display, and a communication device 106 such as a network card and a wireless communication module, or a computer system including a plurality of such computers.

For example, the worktime function calculation unit 131, the worktime for each capability calculation unit 132, the process planning reception unit 133, the production planning reception unit 134, the work promotion information generation unit 135, and the workability improvement information generation unit 136 of the control unit 130 can be implemented by loading a predetermined program stored in the external storage device 103 in the memory 102 and causing the CPU 101 to execute the program. The storage unit 110 can be implemented by the CPU 101 using the memory 102 or the external storage device 103.

The target throughput information 111, the standard worktime for each process information 112, the throughput reduction rate information 113, the worktime for each capability allowable value information 114, the actual throughput information 115, the process-basis actual worktime information 116, the process planning information 117, the production planning information 118, the work promotion master information 119, the workability improvement master information 120, the process-basis work promotion information 121, and the process-basis workability improvement information 122, which are stored in the storage unit 110, are implemented by the memory 102 and the external storage device 103.

The input unit 141 is implemented by the input device 104, and the output unit 142 is implemented by the output device 105. The communication unit 143 connected to a wide area network (WAN), a local area network (LAN), or the like in a communicable manner is implemented by the communication device 106.

Note that the production information generation device 100 is not limited thereto, and may be implemented by an application specific integrated circuit (ASIC) or a microcomputer, for example.

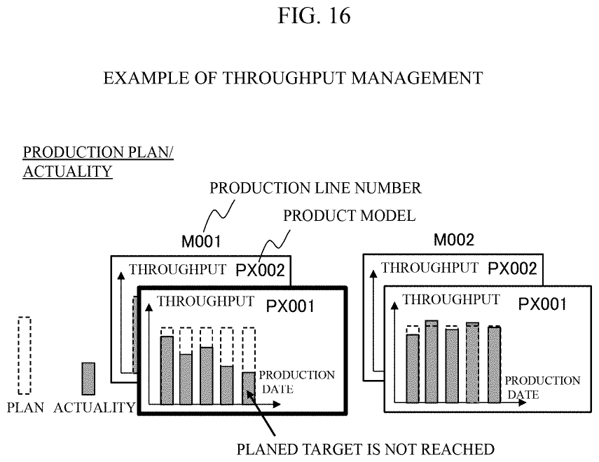

FIG. 16 is a diagram illustrating an example of throughput management. In a factory that produces products, whether an actual throughput reaches a target throughput in a predetermined production plan is managed. In the illustrated example, for each combination of the production line and the product model, an actual throughput is displayed with a solid bar graph with respect to a target throughput indicated with a chain bar graph for each production date. With regard to a product model “PX001” in the production line “M001”, it is indicated that the plan is not achieved.

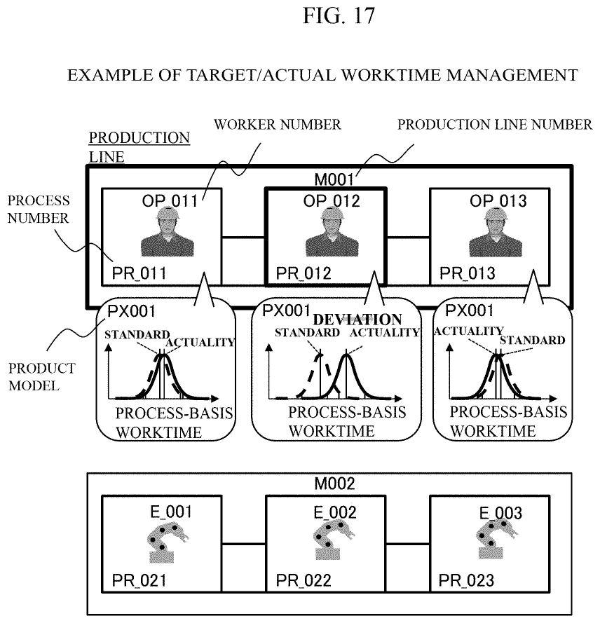

FIG. 17 is a diagram illustrating an example of target/actual worktime management. In a factory that produces products, whether actual worktime meets standard worktime predetermined for each process is managed. In the illustrated example, a gap between the standard and the actuality is large in the process “PR_012” in the production line “M001”. It is considered that a worker “OP_012” allocated to the process has workability lower than the standard. In this case, when the worktime for each capability is applied to the worker in the process in the production line as a target, a production manager instructs execution of processing for generating production information, which is described later, via the input unit 141. With this, the processing is started. Alternatively, when a difference between a daily or weekly or other target throughput and an actual throughput is equal to or greater than a predetermined value, the processing for generating production information is set to be automatically executed. In this case, the processing is started with such a trigger. The processing is executed for all the processes in which a deviation of actual worktime from the standard worktime is large. Thus, when a user specifies a plurality of processes, or a plurality of processes are specified during automated execution, the production information generation processing is executed repeatedly for the number of the processes.

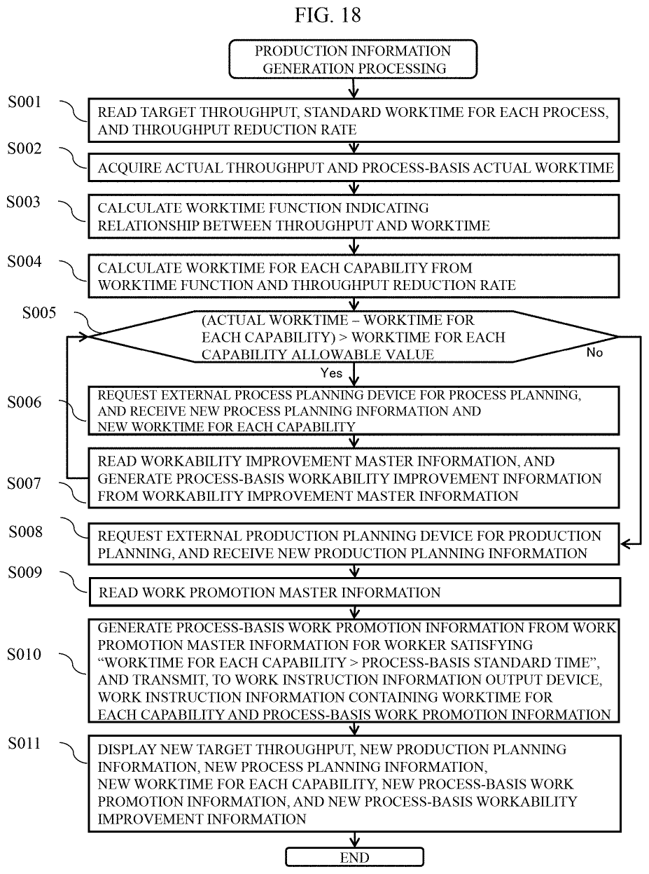

FIG. 18 is a diagram illustrating a flow of production information generation processing. As described above, when the input unit 141 receives an instruction of executing the production information generation, or a difference between a daily or weekly or other target throughput and an actual throughput is equal to or greater than a predetermined value, the present processing flow is started for a production line, a product model, a process number, and a worker as processing targets, corresponding to the gap in the throughput.

First, from the target throughput information 111, the standard worktime for each process information 112, and the throughput reduction rate information 113, the worktime function calculation unit 131 reads a target throughput, standard worktime for each process, and a throughput reduction rate of a production line and a product model being targets (Step S001).

Further, from the actual throughput information 115 and the process-basis actual worktime information 116, the worktime function calculation unit 131 reads an actual throughput of the production line and the product model being targets and process-basis actual worktime of a process number and a worker number being targets (Step S002).

Further, the worktime function calculation unit 131 calculates a worktime function by using the information on the target throughput and the standard worktime for each process that are read in Step S001 and the actual throughput and the process-basis actual worktime that are read in Step S002 (Step S003).

Further, the worktime for each capability calculation unit 132 calculates worktime for each capability using the throughput reduction rate that is read in Step S001 and the worktime function that is calculated in Step S003 (Step S004).

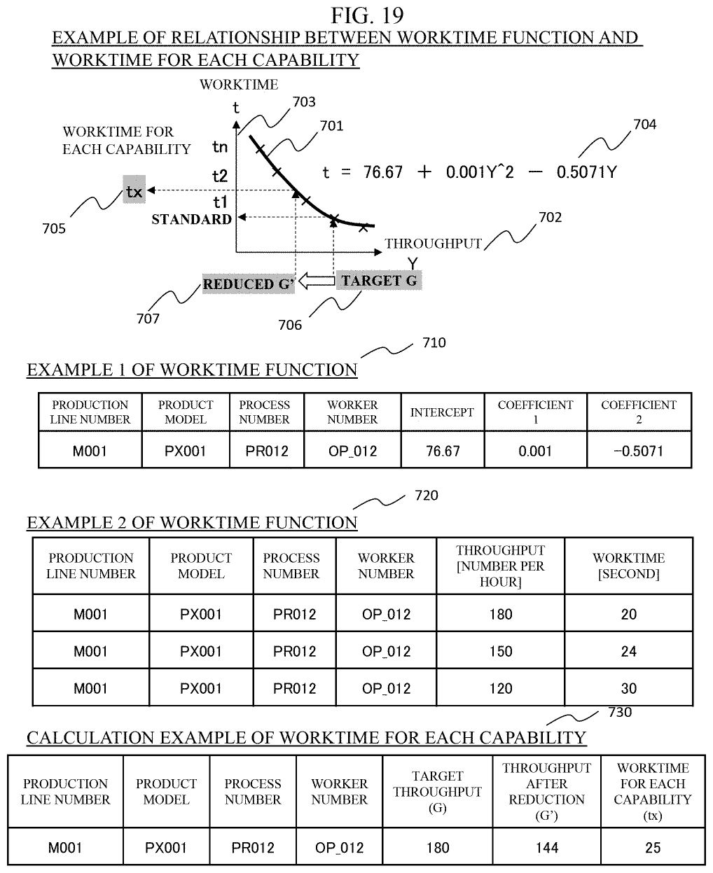

FIG. 19 is a diagram illustrating an example of a relationship between the worktime function and the worktime for each capability. As illustrated in FIG. 19, the worktime function calculation unit 131 specifies an approximate expression 701 for the throughput and the worktime as a worktime function 704. The approximate expression 701 is obtained by plotting the read actual throughput and process-basis actual worktime data for each worker in a graph that has a horizontal axis indicating a throughput 702 and a vertical axis indicating worktime 703.

As an example of a data structure of the worktime function 704, an example 710 in which an approximate curve using plotted dots is calculated as an approximate expression contains information of an intercept and coefficients of the approximate expression. An example 720 performing calculation by using plotted dots as a segment linear table contains association information between a plurality of throughputs and worktime.

The worktime for each capability calculation unit 132 uses the worktime function 704 as described above, and specifies worktime for each capability. The worktime for each capability calculation unit 132 calculates a reduced throughput G′707 by multiplying the throughput reduction rate by a target throughput G706, and calculates worktime tx corresponding to the reduced throughput G′707 as worktime for each capability 705 by using the calculated worktime function 704. An example 730 for calculating worktime for each capability is an example for calculating the worktime for each capability 705.

Description refers back to the flowchart in FIG. 18. The process planning reception unit 133 calculates a difference between the process-basis actual worktime read in Step S002 and the worktime for each capability calculated in Step S004, or, if worktime for each capability is specified in Step S006, the specified worktime for each capability, and determines whether the difference exceeds a predetermined threshold value (worktime for each capability allowable value) (Step S005). When the difference does not exceed the worktime for each capability allowable value (“No” in Step S005), the process planning reception unit 133 proceeds the control to Step S008 described later.

When the difference between the worktime for each capability and the process-basis actual worktime exceeds the worktime for each capability allowable value (“Yes” in Step S005), the process planning reception unit 133 requests the external process planning device 300 for process planning, and receives new process planning information and worktime for each capability (Step S006). When a difference between the worktime for each capability and the process-basis actual worktime is large, it is considered that it requires a lot of time for a worker with current workability to meet the worktime for each capability. With this, efficiency degradation of the entire production line is caused, or the worker is mentally stressed by trying to recover from a delay, which reduces a throughput or causes a defect. Thus, the processing is executed for the purpose of avoiding these problems. When the difference exceeds the predetermined threshold value (worktime for each capability allowable value), the current process planning information and the actual worktime are transmitted to the external process planning device 300 to request process replanning, and new process planning information and worktime for each capability are received.

As described above, when it is estimated that current workability of a worker is lower than the standard, it is necessary to promote improvement in proficiency and capability of the worker. Thus, in the present embodiment, a measure for improving proficiency of work while performing work in the production line and a measure for improving capability by providing a training course through use of the training management device 500 outside the production line 600 are achieved.

The workability improvement information generation unit 136 reads the workability improvement master information 120, and generates the process-basis workability improvement information 122 for a relevant process and a relevant worker from the workability improvement master information 120 (Step S007). Further, the workability improvement information generation unit 136 returns the control to Step S005.

The production planning reception unit 134 requests the external production planning device 200 for production planning, and receives new production planning information (Step S008). Specifically, the production planning reception unit 134 transmits the worktime for each capability specified in Step S004 or Step S006 and the current production planning information to the external production planning device 200 to request for production planning, and receives new production planning information.

Further, the work promotion information generation unit 135 reads the work promotion master information 119 (Step S009).

Further, from the work promotion master information 119, the work promotion information generation unit 135 generates process-basis work promotion information on a process and a worker with worktime for each capability greater than the standard worktime for each process, and transmits work instruction information containing the worktime for each capability and the process-basis work promotion information to a work instruction information output device (Step S010). Specifically, the work promotion information generation unit 135 extracts, from the work promotion master information 119 read in Step S009, a worker allocated to a process in which the worktime for each capability specified in Step S004 or Step S006 is greater than the process-basis standard time read in Step S001, and generates process-basis work promotion information on the worker. For example, the process-basis work promotion information is generated by applying work promotion information with the same process number. In addition, work contents included in the process are registered in accordance with work types such as cover assembling and screw fastening. With this, the process-basis work promotion information may be generated by applying work promotion information of the same work type.

Further, the output unit 142 displays a new target throughput, new production planning information, new process planning information, and new worktime for each capability. A control unit 620 of the production line 600 is instructed to cause the output unit 632 to output the worktime for each capability and the process-basis work promotion information. The training management device 500 is instructed to accumulate the process-basis workability improvement information and prepare for output (Step S011).

The flow of the production information generation processing is as described above. According to the production information generation processing, various types of production information can be generated depending on a target throughput, the information in which a capability difference among workers, who are in a production line separated into a plurality of steps, is reflected.

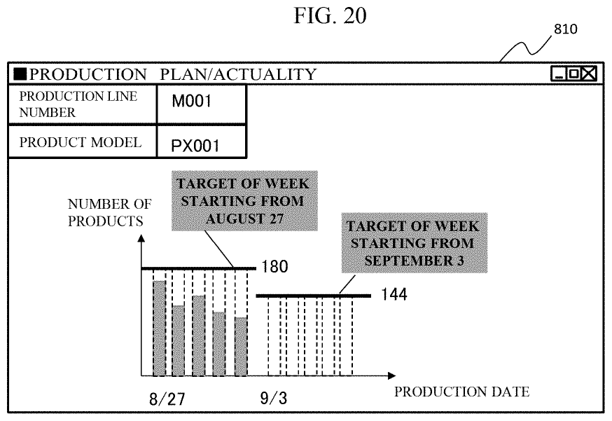

FIG. 20 is a diagram illustrating an output screen example for production planning. An output screen example 810 for production planning illustrates a graph including a target throughput for each production date for each combination of a production line number and a product model, as the production planning information received in Step S007. In the illustrated example, given is a case where a target throughput before reduction and a reduced target throughput after September 3, which is calculated in the processing of the present invention, are displayed in a comparison manner.

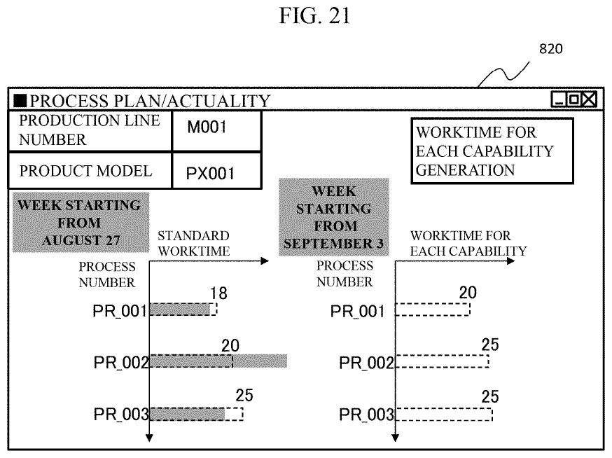

FIG. 21 is a diagram illustrating an output screen example for process planning. In an output screen example 820 for process planning, the process-basis worktime for each capability calculated in Step S004 or S006 is displayed for each combination of a production line number and a product model. In the illustrated example, given is a case where standard worktime for each process before reduction of the target throughput and worktime for each capability after reduction of the target throughput are displayed in a comparison manner.

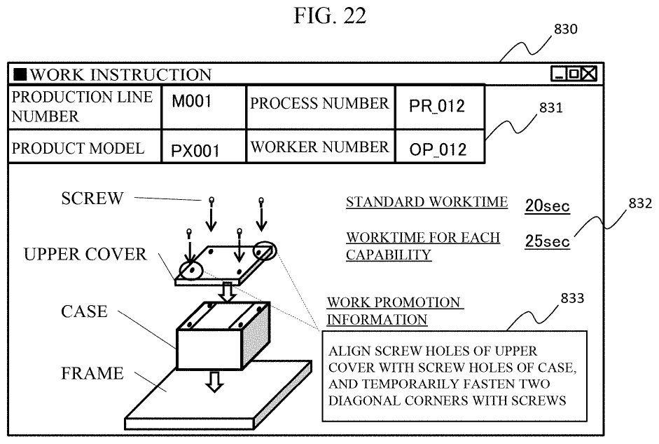

FIG. 22 is a diagram illustrating an output screen example for a work instruction. As the process-basis work promotion information generated in Step S010, an output screen example 830 for a work instruction includes information pieces of worktime for each capability 832, work promotion information 833 such as character information indicating cautions, illustration indicating a component related to cautions, and the like for improving work speed or accuracy, for each combination 831 of a production line number, a product model, a process number, and a worker number. It is assumed that the process-basis work promotion information is referred for the purpose of improving proficiency while performing work in the production line, and hence the information indicates cautions for promoting proficiency of work in the process, such as a tip on the work.

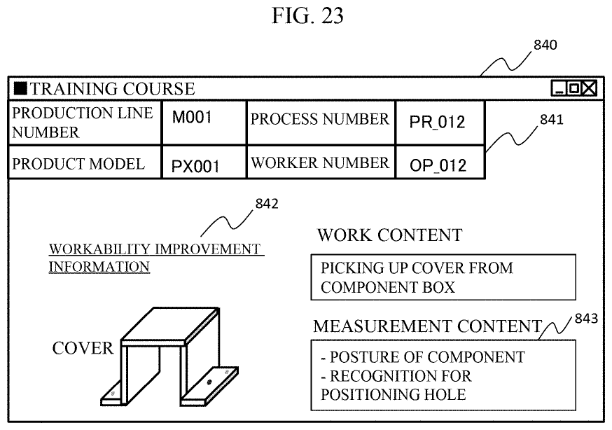

FIG. 23 is a diagram illustrating an output screen example for a training course. An output screen example 840 for a training course includes the process-basis workability improvement information generated in Step S007. The process-basis workability improvement information contains workability improvement information 842 including character information indicating a work content, illustration information indicating a component being a work target, and information on a measurement content 843 at the time of performing work, for each combination 841 of a production line number, a product model, a process number, and a worker number, for example.

It is assumed that the process-basis workability improvement information is information to be referred to and used during training time or the like newly provided for an individual worker outside work in a production line. Thus, the information contains information on a measurement content having an impact on workability for each work content. By recording worktime and measurement information, information for promoting capability improvement, which indicates a task that an individual worker is good at, a task that can be easily learned, a task that requires practice, and the like, is more likely to be analyzed, and a worker is more likely to achieve work within the standard time at an early stage.

The embodiment of the present invention is described above. According to the embodiment described above, various types of production information can be generated depending on a target throughput, the information in which a capability difference among workers, who are in a production line separated into a plurality of steps, is reflected.

Note that the present invention is not limited to the above-mentioned embodiment, but includes various modification examples. For example, the embodiment described above is described in detail for the sake of better understanding of the present invention, and the present invention is not necessarily limited to including all the configurations described herein.

For example, in a process to which a human worker is allocated instead of machine equipment, it can be expected to moderate and eliminate a capability difference among workers by executing the production information generation processing described above. However, in a process to which machine equipment is allocated, in order to solve reduction of a throughput, it is required to improve information for controlling the equipment and eliminate degradation through maintenance. As a second embodiment, description is given below on a production information generation system that is applied to such case or an environment in which a process performed by a worker and a process performed by machine equipment are both present. Note that the production information generation system according to the second embodiment includes a configuration substantially the same as that of the production information generation system according to the first embodiment, but is partially different. The differences are mainly described below.

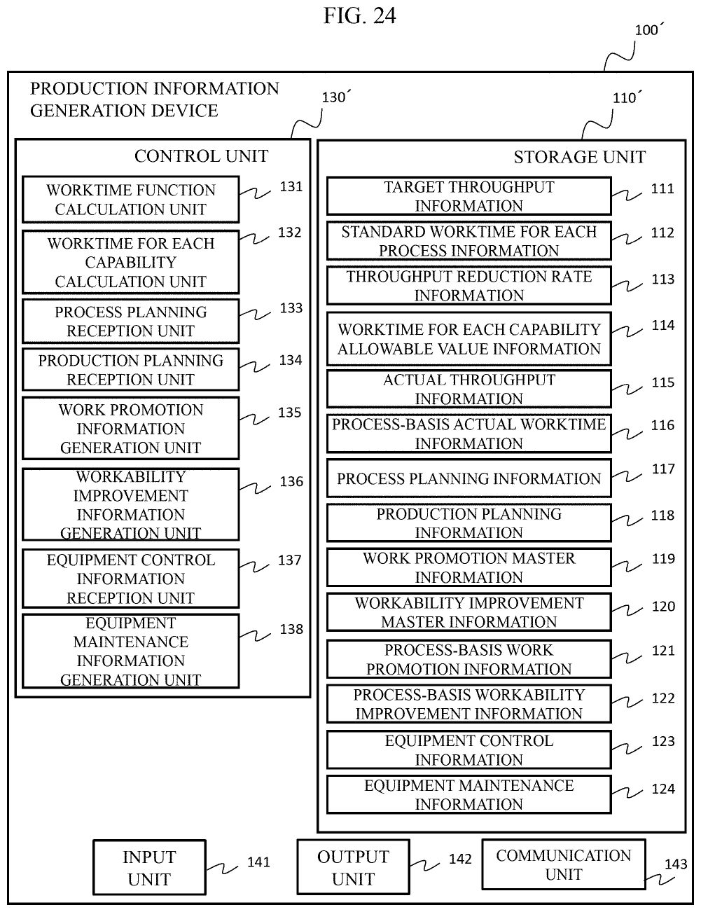

FIG. 24 is a diagram illustrating a configuration example of a production information generation device according to the second embodiment. A storage unit 110′ of a production information generation device 100′ according to the second embodiment includes equipment control information 123 and equipment maintenance information 124 in addition to the storage unit 110 of the production information generation device 100 according to the first embodiment. A control unit 130′ of the production information generation device 100′ according to the second embodiment includes an equipment control information reception unit 137 and an equipment maintenance information generation unit 138 in addition to the control unit 130 of the production information generation device 100 according to the first embodiment.

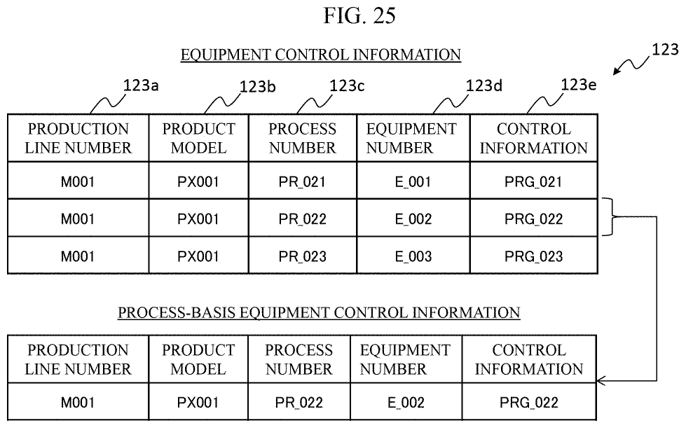

FIG. 25 is a diagram illustrating a data structure example of equipment control information and process-basis equipment control information. The equipment control information 123 contains a production line number 123a, a product model 123b, a process number 123c, an equipment number 123d, and control information 123e. The production line number 123a is information for specifying an individual production line constituting the production line 600. The product model 123b is information for specifying a product or a component to be produced. The process number 123c is information for specifying a production process constituting an individual production line.

The equipment number 123d is information for specifying work equipment. The control information 123e is a numerical control program (NC program) or a robot program for controlling an operation of equipment. The original control information is changed in a speed instruction value or coordinate values for instructing a passing point. With this, control information suitable for equipment capability can be provided.

The process-basis equipment control information is obtained by extracting, from the equipment control information 123, control information on a predetermined process (process number) as a target of control change.

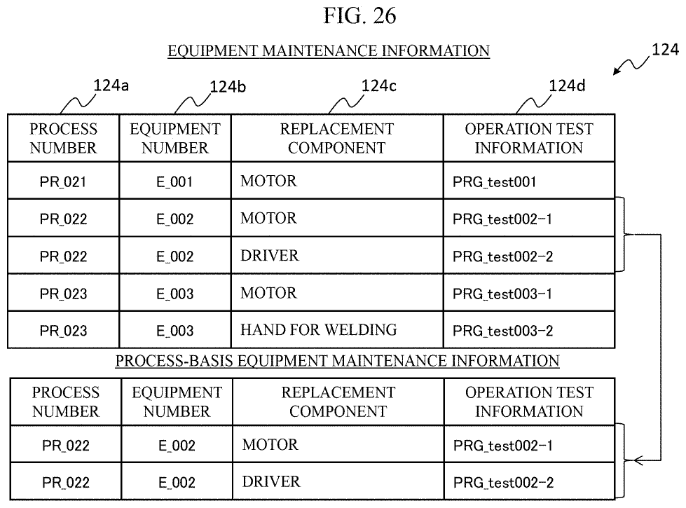

FIG. 26 is a diagram illustrating a data structure example of equipment maintenance information and process-basis equipment maintenance information. The equipment maintenance information 124 contains a process number 124a, an equipment number 124b, a replacement component 124c, and operation test information 124d. The process number 124a is information for specifying a production process constituting an individual production line. The equipment number 124b is information for specifying work equipment. The replacement component 124c is information for specifying a component to be replaced during maintenance. The operation test information 124d is a numerical control program (NC program) or a robot program for controlling an operation of equipment. The operation test information 124d is control information for testing an operation state of a replacement component.

The process-basis equipment maintenance information is obtained by extracting, from the equipment maintenance information 124, a replacement component and operation test information on a predetermined process (process number) as a target of maintenance.

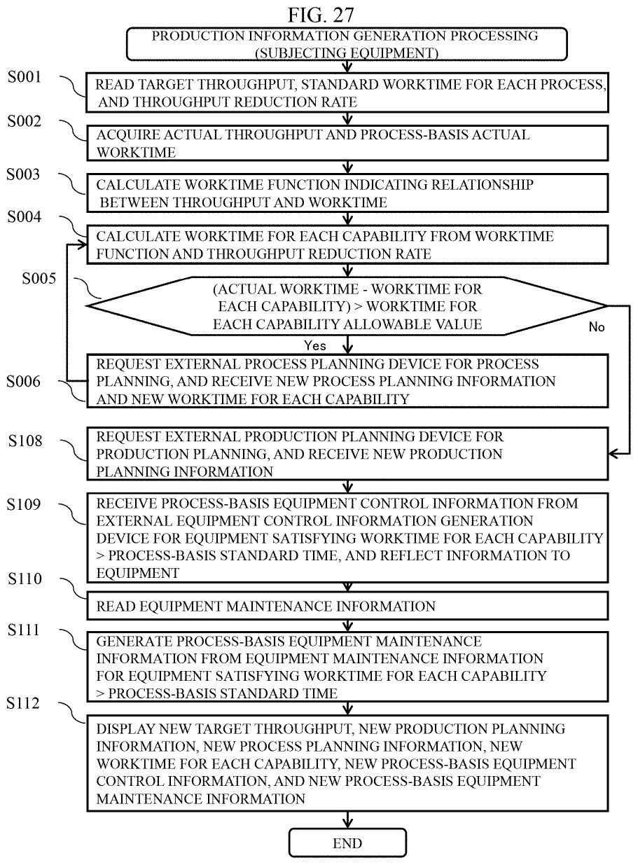

FIG. 27 is a diagram illustrating an example of a flow of production information generation processing (subjecting equipment). As described above, when the input unit 141 receives an instruction of executing the production information generation, or a difference between a daily or weekly or other target throughput and an actual throughput is equal to or greater than a predetermined value, the present processing flow is started for a production line, a product model, a process number, and equipment as processing targets, corresponding to the gap in the throughput.

Note that the flow of the production information generation processing (subjecting equipment) shares common parts with the control from Step S001 to Step S006 in the production information generation processing. Thus, differences are mainly described.

In the second embodiment, the process planning reception unit 133 returns the control to Step S005 after executing Step S006.

In Step S005, when a difference between the process-basis actual worktime read in Step S002 and the worktime for each capability calculated in Step S004, or, if worktime for each capability is specified in Step S006, the specified worktime for each capability, does not exceed the predetermined threshold value (worktime for each capability allowable value) (“No” in Step S005), the process planning reception unit 133 proceeds the control to Step S108.

The production planning reception unit 134 requests the external production planning device 200 for production planning, and receives new production planning information (Step S108). Specifically, the production planning reception unit 134 transmits the worktime for each capability specified in Step S004 or Step S006 and the current production planning information to the external production planning device 200 to request for production planning, and receives new production planning information.

Further, for a process and equipment having worktime for each capability greater than standard worktime for each process, the equipment control information reception unit 137 receives process-basis equipment control information from the external equipment control information generation device 400, and reflects the information to the equipment (Step S109). Specifically, the equipment control information reception unit 137 transmits the worktime for each capability specified in Step S004 or Step S006 and the current production planning information to the external equipment control information generation device 400 to request for process-basis equipment control information, and reflects the information to the control of the equipment.

Further, the equipment maintenance information generation unit 138 reads the equipment maintenance information 124 (Step S110).

Further, for a process and equipment having worktime for each capability greater than standard worktime for each process, the equipment maintenance information generation unit 138 generates process-basis equipment maintenance information from the equipment maintenance information 124 (Step S111). Specifically, after specifying the process, the equipment maintenance information generation unit 138 specifies equipment allocated to the process, and generates process-basis equipment maintenance information from the equipment maintenance information 124.

Further, the output unit 142 displays a new target throughput, new production planning information, new process planning information, new worktime for each capability, and new process-basis equipment maintenance information. The control unit 620 of the production line 600 is instructed to enable usage of the process-basis equipment control information by control unit 142 (Step S112).

The flow of the production information generation processing (subjecting equipment) is as described above. According to the production information generation processing (subjecting equipment), various types of production information can be generated depending on a target throughput, the information in which a capability difference among equipment pieces, which are in a production line separated into a plurality of steps, is reflected.

In this way, applying the second embodiment to the production information generation system enables worktime for each capability to be applied to a case where work equipment is allocated to a process or work equipment used by a worker is allocated to a process, as well as to a case where a worker is allocated to a process. Thus, the target throughput can be achieved efficiently.

The production information generation system according to the present invention is not limited to such modification, and a part of the configuration of each of the embodiments may be added to, eliminated from, or replaced with another configuration.

A part or an entirety of each configuration, function, processing unit, and the like described above may be implemented with hardware by, for example, designing of an integrated circuit. Each configuration, function, and the like described above may be implemented with software control for executing an arithmetic operation in accordance with a program of a processor that achieves each function. Information on a program, a table, a file, and the like that achieve each function may be stored in a recording device such as a memory, a hard disk, and an SSD, or a recording medium such as an IC card, a memory card, and a DVD, may be read in a random access memory (RAM) or the like at the time of execution, and may be executed by a CPU or the like.

Illustrations of control lines and information lines are those considered to be necessary for the sake of description, and not necessarily include all the control lines and information lines necessary as a product. In actuality, it may be considered that substantially all the configurations are connected to one another.

A part or an entirety of each configuration, function, processing unit, and the like described above may be implemented by a distributed system. For example, a part or an entirety of each configuration, function, processing unit, and the like may be executed by different devices and may be integrated via a network.

The technical elements in the above-mentioned embodiments may be applied independently, or may be applied to a plurality of divided parts such as program components and hardware components.

The present invention is as described above mainly with the embodiments.

### REFERENCE SIGNS LIST

50, 50′: Network

100: Production information generation device

200: Production planning device

300: Process planning device

400: Equipment control information generation device

500: Training management device

600: Production line

What is claimed is:

1. A production information generation system comprising:
a production information generation device; and
a work instruction information output device connected to the production information generation device via a network in a communicable manner,
the production information generation device including:
a storage unit configured to store actual information containing an actual value of worktime in a predetermined process and a throughput of a product, and work promotion master information containing predetermined work promotion information for each process,
a worktime function calculation unit configured to calculate a worktime function for each process and each worker, the worktime function indicating a correlation between the actual value of worktime in the process and the throughput of the product;
a worktime for each capability calculation unit configured to calculate, for each process and each worker, worktime for each capability for obtaining a predetermined throughput by using the worktime function;
a work instruction information generation unit configured to generate, for each worker, work instruction information containing the worktime for each capability and the work promotion information on the process; and
a communication unit configured to transmit the work instruction information to the work instruction information output device, and
the work instruction information output device including an output unit configured to receive the work instruction information and display at least the worktime for each capability.

2. The production information generation system according to claim 1, wherein
the worktime for each capability calculation unit calculates the worktime for each capability for a worker whose actual value of worktime in the process exceeds predetermined standard worktime.

3. The production information generation system according to claim 1, wherein
the output unit displays the work promotion information.

4. The production information generation system according to claim 1, comprising;
a process planning reception unit configured to apply process planning for reconstituting work in the process when a difference between the worktime for each capability and the actual value of the worktime exceeds a predetermined value.

5. The production information generation system according to claim 1, comprising;
an equipment control information reception unit configured to generate control information containing the worktime for each capability for each work equipment and equipment control information for determining control of the work equipment in the process, wherein
the worktime for each capability calculation unit calculates, for each process and each work equipment, worktime for each capability for obtaining a predetermined throughput by using the worktime function, and
the communication unit transmits the control information to the work equipment.

6. The production information generation system according to claim 1, comprising:
a training management device configured to perform work training for the worker, wherein
the production information generation device includes:
in the storage unit, workability improvement information containing training information for improving predetermined workability for each process; and
a workability improvement information generation unit configured to generate the workability improvement information for each worker,
the communication unit transmits the workability improvement information to the training management device, and
the training management device includes
a workability improvement information output unit configured to output the workability improvement information.

7. A production information generation device comprising:
a storage unit configured to store actual information containing an actual value of worktime in a predetermined process and a throughput of a product, and work promotion master information containing predetermined work promotion information for each process,
a worktime function calculation unit configured to calculate a worktime function for each process and each worker, the worktime function indicating a correlation between the actual value of worktime in the process and the throughput of the product;
a worktime for each capability calculation unit configured to calculate, for each process and each worker, worktime for each capability for obtaining a predetermined throughput by using the worktime function;
a work instruction information generation unit configured to generate, for each worker, work instruction information containing the worktime for each capability and the work promotion information on the process; and
a communication unit configured to transmit the work instruction information to an external work instruction information output device connected via a network.

8. The production information generation device according to claim 7, wherein
the worktime for each capability calculation unit calculates the worktime for each capability for a worker whose actual value of worktime in the process exceeds predetermined standard worktime.

9. The production information generation device according to claim 7, comprising
a display unit configured to display the worktime for each capability.

10. The production information generation device according to claim 7, comprising
a process planning reception unit configured to apply process planning for reconstituting work in the process when a difference between the worktime for each capability and the actual value of the worktime exceeds a predetermined value.

11. The production information generation device according to claim 7, comprising:
an equipment control information reception unit configured to generate control information containing the worktime for each capability for each work equipment and equipment control information for determining control of the work equipment in the process, wherein
the worktime for each capability calculation unit calculates, for each process and each work equipment, worktime for each capability for obtaining a predetermined throughput by using the worktime function, and
the communication unit transmits the control information to the work equipment.

12. The production information generation device according to claim 7, further comprising:
a training management device configured to perform work training for the worker, wherein
the storage unit stores workability improvement information containing training information for improving predetermined workability for each process,
the production information generation device includes a workability improvement information generation unit configured to generate the workability improvement information for each worker, and
the communication unit transmits the workability improvement information to the training management device for work training for the worker.

13. A production information generation method using
a production information generation device; and
a work instruction information output device connected to the production information generation device via a network in a communicable manner,
the production information generation device including:
a storage unit configured to store actual information containing an actual value of worktime in a predetermined process and a throughput of a product, and work promotion master information containing predetermined work promotion information for each process, a control unit, and a communication unit,
the production information generation method comprising:
performed by the control unit,
a worktime function calculation step of calculating a worktime function for each process and each worker, the worktime function indicating a correlation between the actual value of worktime in the process and the throughput of the product;
a worktime for each capability calculation step of calculating, for each process and each worker, worktime for each capability for obtaining a predetermined throughput by using the worktime function; and
a work instruction information generation step of generating, for each worker, work instruction information containing the worktime for each capability and the work promotion information on the process; and
performed by the communication unit,
a transmitting step of transmitting the work instruction information to the work instruction information output device, wherein
the work instruction information output device includes
a communication unit and an output unit,
the communication unit receive the work instruction information, and
the output unit displays at least the worktime for each capability.

14. The production information generation method according to claim 13, wherein
in the worktime for each capability calculation step, the worktime for each capability is calculated for a worker whose actual value of worktime in the process exceeds predetermined standard worktime.

15. The production information generation method according to claim 13, wherein
the output unit displays the work promotion information.

16. The production information generation method according to claim 13, wherein
the control unit performs
a process planning reception step of applying process planning for reconstituting work in the process when a difference between the worktime for each capability and the actual value of the worktime exceeds a predetermined value.

17. The production information generation method according to claim 13, wherein
the control unit performs
an equipment control information reception step of generating control information containing the worktime for each capability for each work equipment and equipment control information for determining control of the work equipment in the process,
in the worktime for each capability calculation step, for each process and each work equipment, worktime for each capability for obtaining a predetermined throughput is calculated by using the worktime function, and
the communication unit transmits the control information to the work equipment.

18. The production information generation method according to claim 13, wherein
the storage unit includes workability improvement information containing training information for improving predetermined workability for each process,
the control unit performs a workability improvement information generation step of generating the workability improvement information for each worker,
in the transmitting step, the workability improvement information for work training for the worker is transmitted to a training management device, and
the training management device performs
a workability improvement information output step of outputting the workability improvement information.
